(19) United States
(12) Patent Application Publication
(10) Pub. No.: US 2004/0057626 A1
(43) Pub. Date: Mar. 25, 2004

(54) Motion estimation using a context adaptive search

(76) Inventors: Tinku Acharya, Chandler, AZ (US); Kalpesh Mehta, Chandler, AZ (US); Hyun Kim, Scottsdale, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/253,835

(22) Filed: Sep. 23, 2002

(51) Int. Cl. G06K 9/36

(52) U.S. Cl. 382/236

(57) ABSTRACT

Embodiments of an image signal processing engine that may be employed for motion estimation calculations is described.

### RELATED APPLICATIONS

This patent application is related to U.S. patent application Ser. No. ______, titled “Method of Performing Motion Estimation” by Kim et al., filed on ______, (attorney docket no. 042390.P8747); U.S. patent application Ser. No. ______, filed on ______, by Acharya et al., titled “Motion Estimation,” (attorney docket 042390.P12539); and U.S. patent application Ser. No. ______, filed on ______ by Acharya et al., titled “Motion Estimation Using a Logarithmic Search,” (attorney docket 042390.P12868), all assigned to the assignee of the present invention and herein incorporated by reference.

### BACKGROUND

The present disclosure relates to motion estimation and, more particularly, to structures and techniques for computing matching criteria typically employed in motion estimation.

Video coding employing Motion Estimation (ME) and/or Motion Compensation (MC) is widely used in various video coding standards and/or specifications, such as MPEG [see Moving Pictures Experts Group, ISO/IEC/SC29/WG11 standard committee]. Advances, for example, in integrated circuit technology, in recent times have made it possible to implement block matching techniques in hardware, such as with silicon or semiconductor devices. An excellent discussion of ME may be found in Bhaskara and Constantis, [see V. Bhaskaran and K. Konstantinides. “Image and Video Compression Standards: Algorithms and Architectures”, Kluwer Academic Publishers, 1995.]

FIG. 1 shows a block diagram of an embodiment of an MPEG type video encoder. For this particular embodiment, a process of block matching involves a reference block and a search window. There are many matching criteria developed in the literature for matching a block of pixels in a video frame (usually the current frame to be encoded) with a block of pixels in the search window in another frame (usually a previous frame). A “reference block” in this context refers to a selected group of pixels from the current frame to be encoded. In MPEG, this is popularly called a macroblock and usually the size of this macroblock is 16×16. A search window in this context refers to a region of pixels from another frame, frequently the previous frame, to be searched to determine the best match. The “Sum-of-Absolute-Difference” (SAD), generally equivalent to the “Mean Absolute Difference” (MAD), is popular amongst a variety of potential matching criteria because of its low computational burden with the ability to omit multiplication or division. Some other examples of matching criteria include Mean Absolute Difference (MAD), Mean Square Error (MSE), Normalized Cross-Correlation Function, Minimized Maximum Error (MiniMax), etc. Of course, any one of a variety of matching criteria may be employed in block matching and, in this context, no particular matching criteria is preferred over any other; although, depending on the particular application, there may be reasons to prefer one over another.

Usually, a search begins with the motion vector, MV=(0,0) or no motion. For this particular embodiment, a search window is the block of pixels from a previous frame around MV=(0,0). The block size and choice of search window size typically reflects an implementation trade-off; therefore, again, no particular size is necessarily preferred over another in this context. For example, the larger the search window, the higher the computational complexity and memory/data bandwidth capability desired, but, likewise, improved is the chance to get a good match. FIG. 1 shows reference block A in the current frame (I) and the best match block B within the search window in the previous frame (P). The displacement (dx, dy) of the matching block B at location/coordinate (x+dx, y+dy) from the reference block A at coordinate (x, y) is called the motion vector and represented as MV=(dx, dy). The technique to compute this MV is popularly referred to as Motion Estimation (ME). There are several motion estimation techniques in the literature [see, for example, V. Bhaskaran and K. Konstantinides. “Image and Video Compression Standards: Algorithms and Architectures”, Kluwer Academic Publishers, 1995.] In this particular embodiment, full-search (FS) Block Matching is employed. However, this approach may be demanding from the viewpoint of raw computational power as well as the appropriate data bandwidth rate desired to support such an approach.

### BRIEF DESCRIPTION OF THE DRAWINGS

The subject matter is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is a schematic diagram illustrating an embodiment of an MEPG video encoder;

FIG. 2 is a schematic diagram illustrating an embodiment of a window search;

FIG. 3 is a schematic diagram illustrating an embodiment of a cross-bar coupled ISP;

FIG. 4 is a schematic diagram illustrating another embodiment of an ISP;

FIG. 5 is a schematic diagram illustrating an embodiment of a technique for pixel data sharing that may be employed by an ISP;

FIG. 6 is a diagram illustrating dataflow for an ISP employing 3 PEs performing parallel calculations;

FIG. 7 is a schematic diagram of an embodiment of a DDR channel for an ISP, such as the embodiment shown in FIG. 6;

FIG. 8 is a schematic diagram of an embodiment of a layout for a GPR.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail in order so as not to obscure the claimed subject matter.

As indicated previously, a full search technique is typically computationally intensive. Therefore, for high speed video encoding applications, it has proven desirable to instead implement other types of window searches, rather than a full search. For example, U.S. patent application Ser. No. ______, titled “Method of Performing Motion Estimation” by Kim et al., filed on ______, (attorney docket no. 042390.P8747), describes, at least in part, a context adaptive search motion estimation technique. A variation of that technique is described below, although the claimed subject matter is not limited in scope to employing that particular technique. Here, the term context adaptive refers to using characteristics of neighboring subdivisions of the video and/or images, such as macroblocks in this example, to narrow the search window.

In video coding using inter-mode coding, a motion vector is coded and transmitted. To reduce the bit budget for motion vector coding, the motion vector components (horizontal and vertical) are typically coded differentially by using a spatial neighborhood of three motion vectors already transmitted. These three motion vectors are candidate predictors for the differential coding. In this particular embodiment, motion vector coding is performed separately on the horizontal and vertical components. For a component, the median value of three candidates may be computed:

Px=Median(MV1x, MV2x, MV3x)

Py=Median(MV1y, MV2y, MV3y)

For example if MV1=(−2,3), MV2=(1,5) and MV3=(−1,7), then Px=1 and Py=5.

MVDx=MVx−Px

MVDy=MVy−Py

A motion vector field may have strong spatial correlation among neighborhood macroblocks. If so, a motion estimation technique may exploit this spatial correlation. For example, instead of looking for the whole search window, it may be desirable to find motion vectors using a smaller window centered by Px and Py depending on Fcode, as explained below. It should be noted that “Fcode” refers to the search window size selection parameter defined by the MPEG standard committee. For Fcode=1, the search window size is 32×32. For Fcode=2, 3, . . . , the search window sizes are 64×64, 128×128, . . . , respectively. This particular embodiment includes the (0,0) motion vector for motion estimation. For example, in one embodiment, choose 5×5 search points for Fcode=1, and 9×9 search points for Fcode=2. Experimental results for this approach are described in the previously referenced patent application.

A representative or sample raw performance and/or bandwidth capability to implement a context adaptive search (CAS) method may be calculated. Computing a motion vector, where, for example, the Sum-of-Absolute Difference (SAD) is employed, involves a comparison between a reference block and a corresponding block in a previous frame in 5 selected positions in a 32×32 search window and 9 selected positions in a 64×64 window, for example. Assume that the size of a search window is S×S, resolution of the video is M×N and the frame rate is F frames per second. For a 16×16 macroblock, for example, the number of SAD computations per second involved in CAS motion estimation is F*(S*S)*(M*N)/(16*16) for a 32×32 search window.

As is well-known, the CCIR standard for video employs resolution of 720×480 at 30 frames per second. In MPEG2 and MPEG4 video, the size of a search window for block matching is 32×32 and the corresponding search window selection mode is indicated by a variable, Fcode=1. For Fcode=2, 3, . . . , the search window sizes are 64×64, 128×128, . . . , respectively. However, for this particular embodiment, a 5×5 search window is employed for Fcode=1 and 9×9 search winder for Fcode=2. Although the claimed subject matter is not limited to these block sizes, resolutions or particular search windows, nonetheless, the computational burden involved for 720×480 resolution video at 30 frames per second is approximately.

Approximately 1.03 Million SAD computations for Fcode=1

Approximately 3.3 Million SAD computations for Fcode=2

Likewise, representative or sample bandwidth calculations may also be performed. A simplifying assumption is that individual processing elements (PE) in the motion estimation architecture do not have local storage within the PE, and, therefore, a PE is feed with pixel information for SAD computations. Data for an SAD computation is 512 Bytes in this embodiment—here, 256 bytes for a reference block and 256 for a matching block. Hence, the data bandwidth per second in this example is as follows.

For Fcode=1, 1.03M*512 Bytes=517 MB

For Fcode=2, 3.3M*512 Bytes=1.69 GB

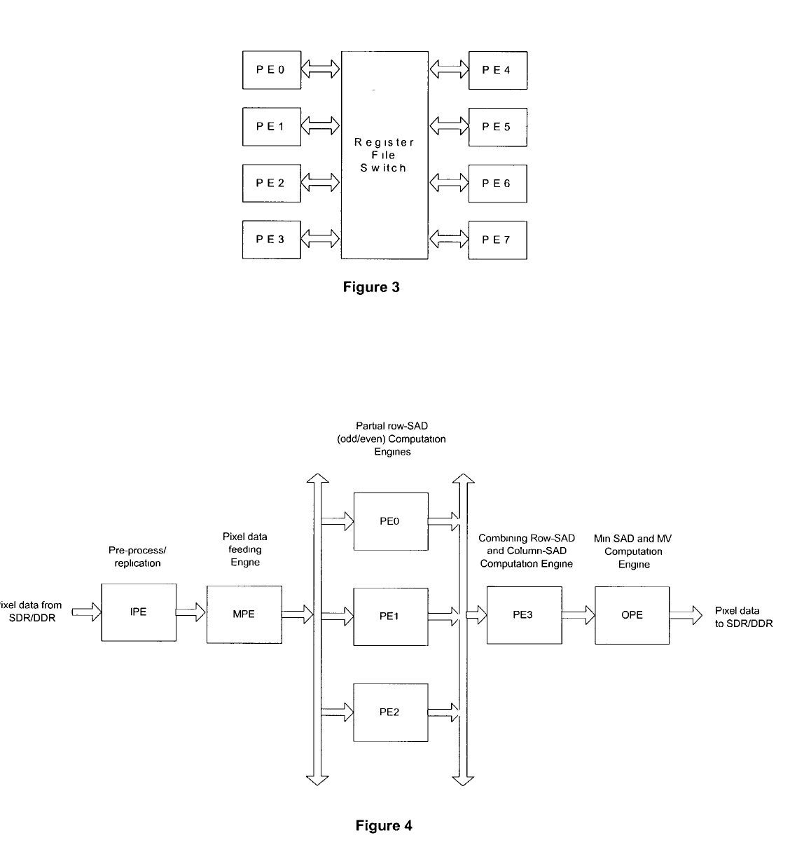

An embodiment of a method for motion estimation employing an architecture 100 that includes a cross-bar coupled image signal processor (ISP) is described. Such an embodiment provides advantages in terms of computational performance and/or bandwidth utilization, as described in more detail hereinafter. Here, an ISP may comprise several basic processing elements (PE) coupled together via a register file switch, as shown in FIG. 3.

Although the claimed subject matter is not limited in scope in this respect, in this particular embodiment, a register file 200 comprises a bank of 16 registers. In this embodiment, a register may be written to by any PE and may be read by any PE. Thus, a register may be used as a link to send data from one PE to another. A register has 8-write ports, so that, for this particular embodiment, any PE may write to it. Likewise, here a register has 8 read port that couples to all PEs. The register file in this embodiment also includes a stalling mechanism that stalls a PE attempting to write when (a) there is a higher priority PE that is also attempting to write in the same cycle and/or (b) the register has unread data. It is of course appreciated that alternate embodiments may omit a register file or may employ a register file with additional and/or different capabilities.

Using general-purpose registers (GPRs) in the register file switch, a PE may communicate with another PE in the ISP in this particular embodiment. Here, there are up to 16 GPRs in a register file switch allowing concurrent communication between various PEs at substantially the same time, if desired.

In this particular embodiment, a GPR may be written and read by any PE. Likewise, in this particular embodiment, a PE may write to and read from any GPR. For example, PEO may use GRO to send data to PE1. At substantially the same time, PE2 may use GR2 to send data to PE4, etc. Thus, although the claimed subject matter is not limited in scope in this respect, there may be up to 16 concurrent transfers occurring on a given cycle.

In this embodiment, therefore, the register file switch provides a mechanism for sharing data between PEs. Although the claimed subject matter is not limited in scope in this respect, in this embodiment, a PE has a dual SAD computation capability by performing SAD computations in parallel. A SAD may be implemented in this embodiment using a special instruction, directed to the processing elements (PEs). One aspect of implementing this particular embodiment is mapping tasks to this architecture so that communication between PEs occurs efficiently with relatively low communication overhead.

In this particular embodiment, as illustrated in FIG. 3, an ISP includes the register file switch to provide a non-blocking mechanism for PEs to mutually communicate. In this embodiment, the register file switch comprises a full N×N switch. A PE may use a register to direct data to one or more PEs. In this particular embodiment, the Data Valid (DV) bits in a register provide a technique of targeting register data to a specific PE or a number of PEs, although, of course, the claimed subject matter is not limited in scope in this respect.

FIG. 8 is a schematic diagram illustrating an embodiment of a layout for a GPR. In this embodiment, a 16-bit data field holds the actual value of the data to be transferred from one PE to one or more other PEs. An 8-bit data field (DV7-DV0) field operates here similar to an address field. It indicates in this embodiment for which PE data is valid. If DV0 is ‘1’, then this data is intended for PEO. Similarly, if DV1=‘1’ then this data is intended for PE1. If all DVx's are 1, (DV0=1, DV1=1, . . . , DV7=1) then this data is intended for all the PEs (e.g., this mechanism provides unicast, multicast and broadcast functionality).

In this embodiment, the PEs within an ISP may be customized to perform specific functions. For example, an input PE (IPE) may be employed to move data into registers on the ISP from a source external to the ISP. Similarly, one or more memory PEs (MPEs) may provide local storage to the PEs. An output PE (OPE) may be employed to move processed data out of an ISP. For example, an IPE and/or OPE may interface to SDR/DDR or other memory technology, for example, to move data into and out of an image processor. A general-purpose PE (GPE) may provide general-purpose processing functionality. In this embodiment, then, although the claimed subject matter is not limited in scope in this respect, for example, an ISP may comprise: an IPE, an OPE, 1 or more MPEs and 1 or more GPEs. The configuration of the ISP may depend, at least in part, on the particular application, including the mapping approach used to map the computation process to the ISP, as described in more detail herein after.

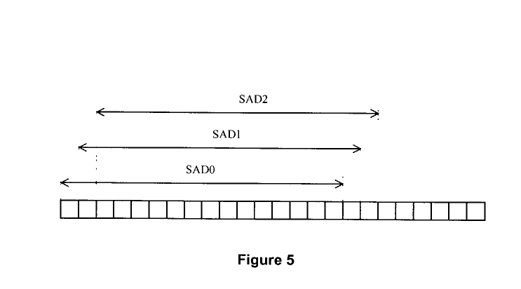

Since the computational power and bandwidth desired may in some instances be relatively high, using a single high-performance processor or a DSP to perform motion estimation may not provide a practical solution. In this embodiment, instead, the LS process is, in essence, “mapped” to multiple ISPs to take advantage of the ISP engines described above. In this particular embodiment, although the claimed subject matter is not limited in scope in this regard, the data and computation flows within the ISP are distributed amongst the PE,s as shown in FIG. 4. The IPE, in this embodiment, for example, could be used to pre-process incoming data, such as replicating the data, rearranging data patterns, etc. The MPEs may receive the reference block and the search window information through an IPE and may store the data in its local memory. FIG. 5 illustrates an embodiment of a memory map for mapping the reference block and search window to MPE0 and MPE1, although, of course, the claimed subject matter is not limited in scope to this particular embodiment. In order to store the reference block and the search window information, about 1.5 KB of memory is desired for MPE0 and 2KB for MPE1, assuming a 32×32 search window:

(MPE0) (16×16)+(32×32)+(16×16) Bytes=˜1.5 KB

(MPE1) (32*32)+(32*32)=2 KB

In order to mitigate potential bandwidth constraints, 3 PEs (e.g., PE0, PE1, PE2 in FIG. 4) are employed in parallel in this embodiment to execute the SAD computation. The 3 PEs are operated in such a way as to share data between them.

In order to illustrate the concept, consider the case where PE0, PE1, and PE2 run in parallel to compute an SAD for consecutive positions in the search window. An MPE may store the reference macroblock and the search region and feed the 3 PEs with data. In this embodiment, the reference macroblock may be fed to PEs using a set of 3 GPRs. The data from a search window in a previous frame may be fed to using a GPR. As an example, FIG. 5 illustrates how 3 PEs may share pixel data to compute 3 SADs in parallel.

Since the PEs are computing the SADs for consecutive positions, as alluded to above, pixel data may be shared in this particular embodiment, although the claimed subject matter is not limited in scope in this respect. For a row of SAD computation, for example, PEO and PEI may share 15 pixels of the reference region and PE1 and PE2 may share 15 pixels. Hence, to feed data to 3 PEs working in parallel, 16+2 pixel data per row for 3 SAD computations may be employed for this embodiment, although, again, the claimed subject matter is not limited in scope to this example embodiment.

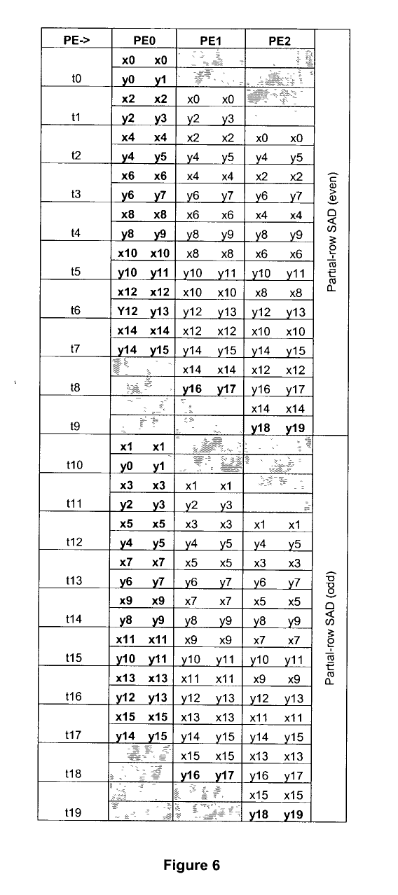

For the following discussion, reference is made to FIG. 6. The data flow of the macroblock and search window between an MPE and the PEs in this particular embodiment is shown in FIG. 6. The data flow is developed in this embodiment using the assumption that an MPE may deliver 2 words in a cycle, although, again, the claimed subject matter is not limited in scope in this respect. The architecture for this particular embodiment is such that it is desirable to provide two words per cycle. The pipeline diagram of FIG. 6 illustrates 2 words per cycle will keep 3 PEs busy and also yield high throughput, as desired. Note that here 3 PEs compute 6 SADs using a dual SAD feature. In this embodiment, 2 SADs/cycle are implemented in a PE utilizing 16 bit data paths. The GPRs and other data paths are 16-bit wide, allowing performance of 2 8-bit operations.

For Fcode=1, 5 SADs per row is desirable. Another assumption for convenience and/or simplicity, as previously indicated, although the claimed subject matter is not limited in scope in l0 this respect, is that a reference block is stored in one block of memory and a search window is stored in another. Thus, two accesses (one for reference block data and another for search window data) are employed per cycle. In FIG. 6, new or additional data provided to a register in a given cycle is shown by bold face.

A parallel process to compute 5 SADs with such an architecture may be expressed in terms of pseudo-code as follows, although the subject matter is not limited in scope in this respect (let us assume that x0, x1, . . . , x15 are the pixels from a row of the reference block and y0, y1, y2, . . . are the corresponding data form the reference block to be matched):

Begin

IPE:

Input the macroblock (x) and the search region (y).
Replicate the pixels (x) into 2 copies;

MPE:

Store replicated x and y into the local memory and feed
them to PE0, PE1, PE2;

for row = 0 to 15 do (sequentially 16 rows are computed)
begin

/* PE0, PE1, PE2 Executes the following
block in parallel */
/* The following tasks T1, T2 and T3 are executed in
pipelined fashion */
T1: Par begin (PEᵢ)

/* Two SAD computations happen in parallel
in each PE */
Compute SADᵢ^{odd} (row) and SADᵢ^{even} (row)
Par end;

T2: PE3

Par: Aᵢ ← Accumulate final SADᵢ^{odd} (row);
Bᵢ ← Accumulate final SADᵢ^{even} (row);

T3: OPE

SADᵢ ← Aᵢ + Bᵢ;
Find minimum SAD and generate motion vector (MV);

End for;

End.

For this particular embodiment, the bandwidth capability desired may be recomputed as follows:

Bandwidth to compute 5 SADs=(16*4+4*2)*16 Bytes=1152 Bytes

Bandwidth to compute 1.03M SADs=1.03M*1152/5=238 MB/s

That represents an overall saving of ˜55% compared to 517 MB/s bandwidth, as computed earlier. The clock cycles to compute a 16×16 SAD may also be determined for this embodiment, e.g., having 3 PEs working in parallel. As discussed, in this example, a PE may compute 2 SADs in parallel, resulting in a potential doubling of the compute performance of the PE. Hence,

Clocks per PE per row of SAD computation=(20/2) clocks

(two SAD computations in parallel, from FIG. 6)

Clocks per PE per 16 rows of SAD computation=(10)*16 clocks

(for a 16×16 macroblock)

Clocks per ISP 16×16 SAD computation=(10*16)/3 clocks=54 clocks

(3 PEs operate in parallel)

Clocks per ISP for 1.03M SAD computation=54*1.03 M clock=55 M clocks

Assuming that ISPs run at 266 MHz, 1 ISP therefore provides the capability to implement CAS processing using a 32×32 search window.

Likewise, bandwidth capability may be determined as follows. An MPE may supply 2 words (16-bits each) per cycle (e.g., 4 bytes per cycle), providing a total bandwidth out of an MPE as 4*266 MB/s or ˜1.064 GB/s. By employing in this embodiment, total bandwidth capability exceeds 1 GB/s, which is higher than the bandwidth of 240 MB/s. Thus, as demonstrated, for this embodiment, 1 ISP may suitably handle the data bandwidth for a 32×32 search window for block matching.

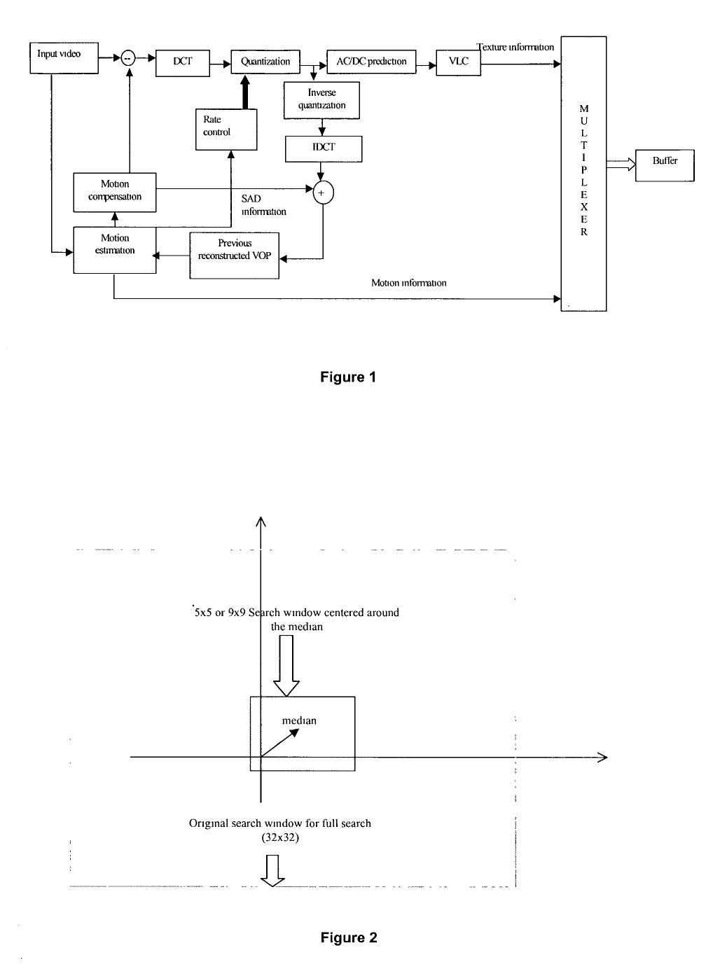

In the above discussion, synchronous DRAM (SDR) and/or dual-data rate DRAM (DDR) bandwidth to download the reference block and search region information to one or more MPEs is now considered. The bandwidth (from FIG. 1) to download the current block and search window to the previously described embodiment is given by,

Bandwidth to download data for 1 macroblock=(16*16) +(32*32) +(16*16) Bytes

Bandwidth to download 1367 blocks=1367*1536 Bytes

Bandwidth desired per second=30*1367*1536 B/s=63 MB/s

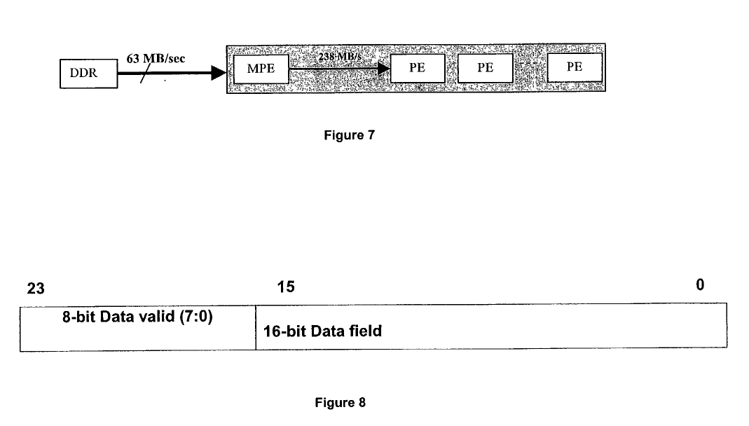

Assuming one DDR channel (16-bit wide and running at 133 MHz), provides a total bandwidth of 2*133*2 MB/s or 512 MB/s, this is more than sufficient. The top level bandwidth estimation at different communication points for this embodiment is illustrated in FIG. 7. A similar analysis may be employed for Fcode=2 (9×9 search).

It will, of course, be understood that, although particular embodiments have just been described, the claimed subject matter is not limited in scope to a particular embodiment or implementation. For example, one embodiment may be in hardware, such as implemented to operate on an integrated circuit chip, for example, whereas another embodiment may be in software. Likewise, an embodiment may be in firmware, or any combination of hardware, software, or firmware, for example. Likewise, although the claimed subject matter is not limited in scope in this respect, one embodiment may comprise an article, such as a storage medium. Such a storage medium, such as, for example, a CD-ROM, or a disk, may have stored thereon instructions, which when executed by a system, such as a computer system or platform, or an imaging or video system, for example, may result in an embodiment of a method in accordance with the claimed subject matter being executed, such as an embodiment of a method of performing motion estimation, for example, as previously described. For example, an image or video processing platform or another processing system may include a video or image processing unit, a video or image input/output device and/or memory.

While certain features of the claimed subject matter have been illustrated and described herein, many modifications, substitutions, changes and equivalents will now occur to those skilled in the art. It is, therefore, to be understood that the appended claims are intended to cover all such modifications and changes as fall within the true spirit of the claimed subject matter.

1. An integrated circuit comprising:
one or more image signal processing engines;
said one or more engines including a plurality of processing elements, said processing elements being mutually coupled by a register file switch;
said plurality of processing elements being further mutually coupled so that, during a block matching calculation, parallel processing and pixel data sharing of pixel locations is employed by said processing elements.

2. The integrated circuit of claim 1, wherein said integrated circuit has a configuration to perform a block matching calculation comprising a sum of absolute differences for a context adaptive search of a search window.

3. The integrated circuit of claim 2, wherein said integrated circuit has a configuration to perform a block matching calculation comprising a sum of absolute differences for a search of a search window based at least in part on a median of components of motion vectors from neighboring marcoblocks.

4. The integrated circuit of claim 1, wherein said image signal processing engine has a configuration so that at least three processing elements, during a block matching calculation, process pixel data in parallel.

5. The integrated circuit of claim 3, wherein said image processing engine further includes at least one processing element coupled to store and feed reference block and search window pixel data values in parallel to said at least three processing elements.

6. The integrated circuit of claim 1, wherein said register file switch includes a plurality of registers coupled so that data is capable of being transferred between any two processing elements.

7. A method of performing image block matching comprising:
during a block matching calculation,
processing pixel locations in parallel; and
sharing overlapping pixel data common to the pixel locations.

8. The method of claim 6, wherein the block matching calculation comprises the sum of absolute differences.

9. The method of claim 8, wherein the block matching calculation comprises the sum of absolute differences applied to a context adaptive search of a search window.

10. The method of claim 9 wherein the block matching calculation comprises the sum of absolute differences applied to a search of a search window based at least in part on a median of components of motion vectors from neighboring marcoblocks.

11. An image processing platform comprising:
an input/output device;
an image processing unit; and
a memory;
said input/output device, image processing unit and memory being mutually coupled;
said image processing unit further including an integrated circuit, said integrated circuit including:
one or more image signal processing engines;
said one or more engines including a plurality of processing elements, said processing elements being mutually coupled by a register file switch;
said plurality of processing elements being further mutually coupled so that, during a block matching calculation, parallel processing and pixel data sharing of pixel locations is employed by said processing elements.

12. The platform of claim 10, wherein said integrated circuit has a configuration to perform a block matching calculation comprising a sum of absolute differences for a context adaptive search of a search window.

13. The platform of claim 12, wherein said integrated circuit has a configuration to perform a block matching calculation comprising a sum of absolute differences for a search of a search window based at least in part on a median of components of motion vectors from neighboring marcoblocks.

14. The platform of claim 10, wherein said image signal processing engine has a configuration so that at least three processing elements, during a block matching calculation, process pixel data in parallel.

15. The platform of claim 12, wherein said image processing engine further includes at least one processing element coupled to store and feed reference block and search window pixel data values in parallel to said at least three processing elements.

16. The platform of claim 10, wherein said register file switch includes a plurality of registers coupled so that data is capable of being transferred between any two processing elements.

17. An article comprising: a storage medium, said medium having stored thereon instructions, said instructions, when executed, resulting in a method of block matching being performed by:
during a block matching calculation,
processing pixel locations in parallel; and
sharing overlapping pixel data common to the pixel locations.

18. The article of claim 15, wherein said instructions, when executed, further resulting in the block matching calculation comprising the sum of absolute differences.

19. The article of claim 17, wherein the instructions, when executed, further resulting in the block matching calculation comprising the sum of absolute differences applied to a context adaptive search of a search window.

20. The article of claim 19, wherein the instructions, when executed, further resulting in the block matching calculation comprising the sum of absolute differences applied to a search of a search window based at least in part on a median of components of motion vectors from neighboring marcoblocks.
